(19) United States
(12) Patent Application Publication
(10) Pub. No.: US 2006/0266323 A1
(43) Pub. Date: Nov. 30, 2006

(54) Control apparatus for vehicle, and vehicle incorporating the same

(75) Inventor: Tomohiko Ogimura, Nissin-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/434,194

(22) Filed: May 16, 2006

(30) Foreign Application Priority Data
May 25, 2005 (JP) 2005-152320

(51) Int. Cl. F02B 77/04; F02M 25/00; F01L 1/34

(52) U.S. Cl. 123/198 A; 123/90.15

(57) ABSTRACT

During the stop of combustion of the internal combustion engine, if deposit accumulation inside the internal combustion engine is large, the VVT mechanism sets the overlap state in which both the intake valve and the exhaust valve attain an open state during the air introduction period set in accordance with the degree of deposit accumulation. In this manner, the air is introduced into the internal combustion engine, and the accumulated deposits are subjected to drying and weathering, so that the deposit removal effect is increased.

This nonprovisional application is based on Japanese Patent Application No. 2005-152320 filed with the Japan Patent Office on May 25, 2005, the entire contents of which are hereby incorporated by reference.

### BACKGROUND OF THE INVENTION

1. Field of the Invention

The present invention relates to a control apparatus for a vehicle, and more particularly to a control apparatus for a vehicle provided with an internal combustion engine, and a vehicle incorporating the control apparatus.

2. Description of the Background Art

It is known that, in an internal combustion engine generating vehicle motive power by burning fuel such as gasoline, there occurs a problem of so-called deposit accumulation where carbides, oxides and the like generated by the fuel combustion would accumulate in the combustion chamber. Such accumulation of deposits is noticeable particularly in an engine provided with an in-cylinder injector (direct injector) that injects fuel directly into the cylinder.

To address this problem, Patent Document 1 (Japanese Patent Laying-Open No. 2002-364409), for example, discloses a technique of fuel injection control in an internal combustion engine provided with both a fuel injection valve (injector) for in-cylinder injection and a fuel injection valve (injector) for intake manifold injection, wherein fuel injection is performed using both the in-cylinder injector and the intake manifold injector as appropriate, so as to prevent accumulation of deposits due to the increase in temperature at the tip end of the in-cylinder injector, that would result from stopping fuel supply from the in-cylinder injector during a homogeneous combustion operation.

Further, for a hybrid vehicle including an electric motor as well as an engine as the vehicle motive power sources arranged in a manner capable of transmitting power to the axle, Patent Document 2 (Japanese Patent Laying-Open No. 10-331677), for example, discloses a technique of preventing engine stall by stopping fuel combustion in the engine at the time of deceleration, while motoring the engine by the electric motor, until the vehicle stops, so as to guarantee favorable driveability and at the same time save the fuel consumption considerably.

Although Patent Document 1 discloses the technique to prevent an increase in temperature at the tip end of the in-cylinder injector so as to suppress accumulation of deposits at the injector, it is completely silent about measures to remove the deposits once accumulated in the internal combustion engine including the intake port and the area in the vicinity of the intake valve.

Further, although Patent Document 2 discloses the technique to prevent engine stall by motoring the engine at the time of deceleration of the hybrid vehicle, it is silent about removal of the deposits in the internal combustion engine.

### SUMMARY OF THE INVENTION

An object of the present invention is to provide a control structure of an internal combustion engine that can increase the effect of removing deposits once accumulated in the internal combustion engine.

A control apparatus for a vehicle according to the present invention controls an internal combustion engine arranged in a manner capable of transmitting power to an axle. The control apparatus includes a detection portion and an air introduction portion. The detection portion detects degree of deposit accumulation in the internal combustion engine. The air introduction portion introduces the air into the internal combustion engine in a combustion stopped state of the internal combustion engine when the detection portion detects that the degree of deposit accumulation is greater than a predetermined level.

A vehicle according to the present invention includes an internal combustion engine and a control apparatus. The internal combustion engine is arranged in a manner capable of transmitting power to an axle. The control apparatus detects degree of deposit accumulation in the internal combustion engine, and introduces the air into the internal combustion engine in a combustion stopped state of the internal combustion engine when a detected value of the degree of deposit accumulation is greater than a predetermined level.

According to this control apparatus for a vehicle and this vehicle, upon detection of deposit accumulation in the internal combustion engine, the air is introduced into the internal combustion engine, while combustion therein is being stopped, to dry and weather the accumulated deposits. This makes the deposits readily be peeled off after initiation of engine combustion next time. As such, the effect of removing deposits once accumulated in the internal combustion engine can be increased.

Preferably, the control apparatus for a vehicle of the present invention further includes a valve control portion that controls opening/closing of an intake valve and an exhaust valve of the internal combustion engine. Further, the air introduction portion instructs the valve control portion to perform control such that the intake valve and the exhaust valve in at least one cylinder are set to an open state (i.e., the overlap state) in the combustion stopped state of the internal combustion engine.

According to this control apparatus for a vehicle, an air introduction path extending from the intake valve through the interior of the combustion chamber to the exhaust valve can be formed in at least one cylinder in the combustion stopped state of the internal combustion engine, e.g., by the valve control portion (variable valve timing (VVT) mechanism) that controls the valve timing (valve phase angle, opening/closing timing) of the intake valve and the exhaust valve of the internal combustion engine. Thus, it is possible to introduce the air into at least one cylinder in the combustion stopped state of the internal combustion engine to dry and weather the once accumulated deposits to make them readily peeled off at the next start of combustion.

Still preferably, in the control apparatus for a vehicle of the present invention, the air introduction portion further includes a cylinder selection portion that selects an air introduction cylinder in which the intake valve and the exhaust valve are set to the open state in the combustion stopped state of the internal combustion engine. Particularly, the cylinder selection portion changes the air introduction cylinder each time the internal combustion engine stops.

According to this control apparatus for a vehicle, even in the configuration where the air introduction path is formed only in a certain cylinder in the combustion stopped state of the internal combustion engine, the air can be introduced into the cylinders by turns, for peeling off and removal of the deposits.

Alternatively, in the control apparatus for a vehicle of the present invention, the vehicle preferably further includes a first electric motor arranged in a manner capable of transmitting power to the internal combustion engine. Further, the air introduction portion performs motoring of the internal combustion engine for a predetermined period by the first electric motor in the combustion stopped state of the internal combustion engine.

According to this control apparatus for a vehicle, the air can be introduced into the internal combustion engine during its combustion stopped state, regardless of setting of the valve timing, by performing motoring of the internal combustion engine in the combustion stopped state. This can further increase the effect of removing the deposits once accumulated in the combustion chamber.

Still preferably, in the control apparatus for a vehicle of the present invention, the vehicle further includes another motive power source different from the internal combustion engine and arranged in a manner capable of transmitting power to the axle, and the control apparatus further includes a motive power allocation portion that controls a motive power output ratio between the internal combustion engine and the other motive power source with respect to total motive power required for the vehicle as a whole. Particularly, the air introduction portion sets motive power output by the internal combustion engine to zero to stop its combustion in the case where the total motive power is not greater than motive power that can be output by the other motive power source and the detection portion detects that the degree of deposit accumulation is greater than the predetermined level.

According to this control apparatus for a vehicle, in the hybrid vehicle provided with the internal combustion engine and the other motive power source, in the case where the other motive power source alone is capable of generating total motive power that is motive power required for the entire vehicle, the combustion in the internal combustion engine can be stopped forcibly so as to allow motoring of the internal combustion engine when deposit accumulation has become greater than a predetermined level. As a result, the effect of removing deposits once accumulated in the internal combustion engine in the hybrid vehicle can be increased.

Particularly in such a configuration, the other motive power source includes a second electric motor arranged in a manner capable of transmitting power to the axle, and the second electric motor has output torque set in accordance with a sum of first torque corresponding to the total motive power and second torque for canceling out torque that is transmitted to the axle by the motoring of the internal combustion engine by the first electric motor.

According to this control apparatus for a vehicle, the second electric motor provided as the other motive power source can cancel out the variation in torque transmitted to the axle during the motoring of the internal combustion engine for removal of deposits. This can suppress occurrence of disturbance in the vehicle motive power because of the deposit removal control.

Alternatively, in the control apparatus for a vehicle of the present invention, the vehicle preferably further includes a catalyst arranged to allow an exhaust gas of the internal combustion engine to pass therethrough, and the control apparatus further include a temperature detection portion and a motoring stop portion. The temperature detection portion detects a temperature of the catalyst. The motoring stop portion stops motoring of the internal combustion engine by the air introduction portion in response to the event that the temperature detection portion detects the temperature of the catalyst decreased to a level lower than a predetermined reference value during the motoring of the internal combustion engine.

According to this control apparatus for a vehicle, it is possible to prevent degradation of exhaust emission efficiency by preventing the temperature of the catalyst from becoming too low due to the motoring of the internal combustion engine for removal of deposits therein.

Still preferably, in the control apparatus for a vehicle of the present invention, the vehicle further includes a catalyst arranged to allow an exhaust gas of the internal combustion engine to pass therethrough, and the control apparatus further includes a temperature detection portion and a motoring prohibiting portion. The temperature detection portion detects a temperature of the catalyst. The motoring prohibiting portion prohibits execution of motoring of the internal combustion engine by the air introduction portion, even in the case where the detection portion detects that the degree of deposit accumulation is greater than the predetermined level, when the temperature detection portion detects that the temperature of the catalyst is lower than a predetermined reference value.

According to this control apparatus for a vehicle, it is possible to prevent degradation of exhaust emission efficiency due to the event that the temperature of the catalyst that is low is further lowered by execution of the motoring of the internal combustion engine for removal of deposits therein.

Still preferably, in the control apparatus for a vehicle of the present invention, the predetermined period of time is set in a variable manner in accordance with the degree of deposit accumulation detected by the detection portion.

According to this control apparatus for a vehicle, the prescribed period of time during which motoring of the internal combustion engine is carried out by the electric motor while stopping combustion therein (i.e., the motoring period) can be set in a variable manner in accordance with the degree of deposit accumulation. Thus, it is possible to set the duration of the motoring period appropriately to prevent unnecessary consumption of the battery power, to thereby improve fuel efficiency.

Still preferably, in the control apparatus for a vehicle of the present invention, the internal combustion engine includes a first fuel injection mechanism provided to inject fuel directly into a combustion chamber.

According to this control apparatus for a vehicle, the deposit removing effect can be increased in the internal combustion engine having the in-cylinder injector (direct injector) in which probability of deposit accumulation is particularly high.

Still preferably, the internal combustion engine further includes a second fuel injection mechanism provided to inject fuel into an intake manifold.

According to this control apparatus for a vehicle, deposit accumulation to the internal combustion engine can be suppressed in the internal combustion engine having both the in-cylinder injector and the intake manifold injector. As a result, the necessity to forcibly set the period of injecting fuel from the in-cylinder injector in a homogeneous combustion mode from the standpoint of preventing deposit accumulation decreases, so that it is possible to set the fuel injection ratio between the injectors ensuring more favorable driveability.

Alternatively, the control apparatus for a vehicle of the present invention preferably further includes an air-fuel ratio control portion that controls a fuel injection amount based on a detected value of an air-fuel ratio in the internal combustion engine so as to maintain the air-fuel ratio at a target value. Further, the detection portion detects the degree of deposit accumulation based on a compensation amount of the fuel injection amount by the air-fuel ratio control portion.

According to this control apparatus for a vehicle, it is possible to detect the degree of deposit accumulation based on the fuel injection compensation amount (air-fuel ratio control learning value) by the air-fuel ratio control portion. This enables efficient and accurate evaluation of the degree of deposit accumulation in the internal combustion engine without the need of providing another sensor or the like.

Accordingly, the primary benefit of the present invention is that it is possible to perform control of the internal combustion engine that can increase the effect of removing the deposits once accumulated inside the internal combustion engine.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an engine system that is controlled by a control apparatus for a vehicle according to a first embodiment of the present invention.

FIG. 2 is a flowchart illustrating deposit removal control in the engine according to the control apparatus for a vehicle of the first embodiment of the present invention.

FIG. 3 is a conceptual diagram illustrating setting of an air introduction period in accordance with the degree of deposit accumulation.

FIG. 4 is a block diagram illustrating another configuration example of the engine system that is controlled by the control apparatus for a vehicle according to the first embodiment of the present invention.

FIG. 5 is a block diagram illustrating a schematic configuration of a hybrid vehicle that is controlled by a control apparatus for a vehicle according to a second embodiment of the present invention.

FIGS. 6-8 are flowcharts illustrating first through third examples, respectively, of deposit removal control according to the second embodiment of the present invention.

FIG. 9 is a flowchart illustrating a modification of the third example of the deposit removal control according to the second embodiment of the present invention.

FIG. 10 is a flowchart illustrating a fourth example of the deposit removal control according to the second embodiment of the present invention.

FIG. 11 is a flowchart illustrating a modification of the deposit removal control according to the first embodiment of the present invention.

### DESCRIPTION OF THE PREFERRED EMBODIMENTS

Embodiments of the present invention will be described in detail hereinafter with reference to the drawings. The same or corresponding elements in the drawings have the same reference characters allotted, and detailed description thereof will not be repeated in principle.

### First Embodiment

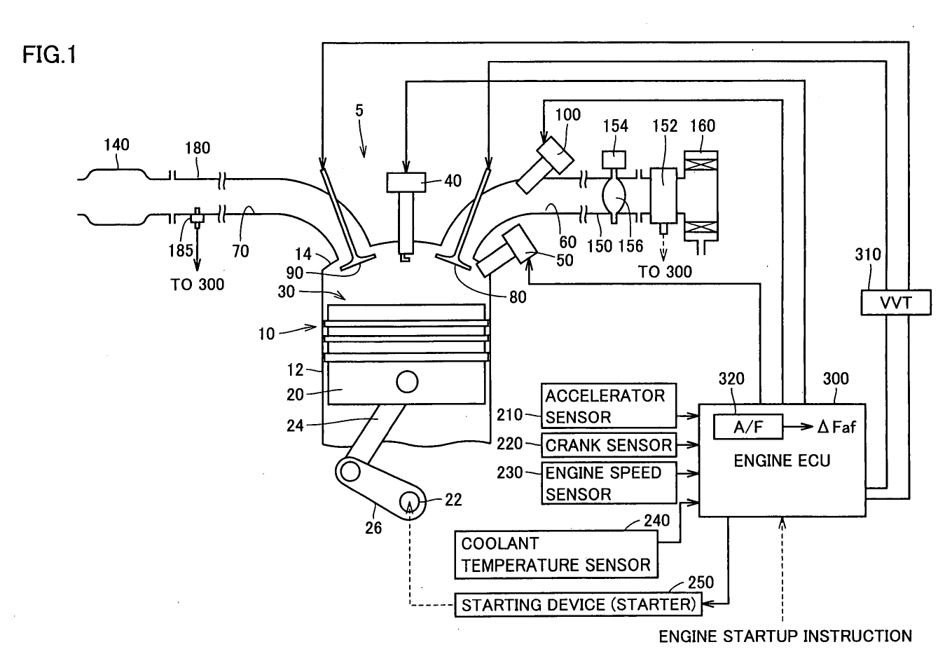

An engine system under control of an engine ECU (Electronic Control Unit) that is a control apparatus for a vehicle according to a first embodiment of the present invention will be described with reference to FIG. 1. Although one cylinder of an engine is shown representatively in FIG. 1, the number of cylinders and arrangement thereof in the internal combustion engine to which the embodiment of the present invention is applied are not limited.

Referring to FIG. 1, an engine 5 is formed to include a cylinder 10 including a cylinder block 12 and a cylinder head 14 connected above cylinder block 12, and a piston 20 that moves back and forth in cylinder 10. Piston 20 has a connecting rod 24 and a crank arm 26 connected to a crankshaft 22 that is the output shaft of engine 5. The reciprocating movement of piston 20 is converted into the rotation of crankshaft 22 by means of connecting rod 24. In cylinder 10, the inner wall of cylinder block 12 and cylinder head 14 and the top plane of piston 20 constitute the partition for a combustion chamber 30 in which air-fuel mixture is burned.

Cylinder head 14 is provided with a spark plug 40 protruding into combustion chamber 30 to ignite the air-fuel mixture, and an in-cylinder injector 50 injecting fuel into combustion chamber 30. Further, an intake manifold injector 100 is provided at an intake manifold 60, which injects fuel into intake manifold 60 and/or an intake port that forms a communicating portion between intake manifold 60 and combustion chamber 30.

In the internal combustion engine of a vehicle to which the present invention is applied, at least one of in-cylinder injector 50 and intake manifold injector 100 may be arranged; provision of both injectors is unnecessarily required. However, as apparent from the following explanation, the present invention is suitably applicable to the vehicle provided with the internal combustion engine having the in-cylinder injector. The present invention is also applicable to an internal combustion engine having a single injector that has both the in-cylinder injection and intake manifold injection functions.

Combustion chamber 30 communicates with intake manifold 60 and an exhaust manifold 70 via an intake valve 80 and an exhaust valve 90, respectively.

Intake manifold 60 is connected to a surge tank (not shown) commonly provided for the cylinders. This surge tank is connected to an air cleaner 160 via an intake duct 150. In intake duct 150, an airflow meter 152 measuring the intake air amount and a throttle valve 156 driven by an electric motor 154 are arranged. Throttle valve 156 has its degree of opening controlled based on an output signal of engine ECU 300 independently from an accelerator pedal.

Exhaust manifold 70 has a portion 180 commonly provided for the cylinders, which portion is connected to a three-way catalytic converter 140. An air-fuel ratio sensor 185 is attached to the portion 180 of the manifold located upstream of three-way catalytic converter 140. Air-fuel ratio sensor 185 provides an output voltage in proportion to an oxygen concentration in the exhaust gas, which voltage is applied to engine ECU 300.

Further, various sensors are provided for engine 5 such as an accelerator sensor 210, a crank sensor 220, an engine speed sensor 230, and a coolant temperature sensor 240.

Accelerator sensor 210 is provided in the proximity of the accelerator pedal (not shown) to detect the accelerator pedal position (press-down degree). The detected value from accelerator sensor 210 is appropriately subjected to A/D conversion at engine ECU 300 to be provided to a microcomputer in engine ECU 300.

Crank sensor 220 is formed of a rotor attached to crankshaft 22 of engine 5, and an electromagnetic pickup, located in the proximity of the rotor for detecting the passage of a projection provided at the outer circumference of the rotor. Crank sensor 220 generates a pulse signal indicating the rotation phase (crank angle) of crankshaft 22. Engine speed sensor 230 generates a pulse signal indicating the engine speed. The pulse signals from crank sensor 220 and engine speed sensor 230 are provided to the microcomputer in engine ECU 300.

Coolant temperature sensor 240 is provided at the channel of the coolant for engine 5, and provides an output voltage in proportion to the engine coolant temperature. The output voltage from coolant temperature sensor 240 is appropriately subjected to A/D conversion at engine ECU 300 to be provided to the microcomputer in engine ECU 300.

Engine ECU 300 executes a predetermined program through the microcomputer to generate various control signals to control the overall operation of the engine system based on the signals from the group of sensors including those shown in FIG. 1.

A starting device (starter) 250 is provided for engine 5. In general, a starter 250 is formed of an electric motor that is energized in response to an operation instruction from engine ECU 300. When an operation instruction is issued from engine ECU 300, the flywheel (not shown) of engine 5 is rotated by starter 250 to start the engine running. The operation instruction to starter 250 is issued in response to an engine startup instruction through a key operation by the driver.

A valve timing control unit (VVT control unit) 310 is further provided to control the opening/closing timing of intake valve 80 and exhaust valve 90. Typically, VVT control unit 310 changes the phase of the camshaft (not shown) of engine 5 by hydraulic pressure or by the output of the electric motor, to variably set the valve timing. The amount of phase change of the camshaft by VVT control unit 310 is set by a control signal from engine ECU 300. VVT control unit 310 corresponds to the “valve control means” of the present invention.

Engine ECU 300 further includes an air-fuel ratio control unit 320 that controls the air-fuel ratio within combustion chamber 30. Air-fuel ratio control unit 320 controls the fuel injection amount based on comparison between the air-fuel ratio detection value detected by air-fuel ratio sensor 185 and an air-fuel ratio set value. The air-fuel ratio set value is set to a value near a stoichiometric air-fuel ratio (e.g., A/F=14.5) in the homogeneous combustion mode, and is set to a value greater than the stoichiometric air-fuel ratio in the stratified charge combustion mode.

Air-fuel ratio control unit 320 sets a fuel injection compensation amount ΔFaf corresponding to a deficiency or excess of fuel with respect to the air-fuel ratio set value, for the fuel injection amount predetermined in association with the engine operation status. With this feedback control, fuel injection compensation amount ΔFaf is learned and controlled sequentially so that the actual air-fuel ratio becomes equal to the air-fuel ratio set value. Hereinafter, fuel injection compensation amount ΔFaf is also referred to as the “air-fuel ratio control learning value”. Engine ECU 300 sets a fuel injection amount set value by adding this air-fuel ratio control learning value ΔFaf to the fuel injection amount theoretically obtained. Air-fuel ratio control unit 320 corresponds to the “air-fuel ratio control means” of the present invention.

When the fuel is burned in engine 5, deposits are accumulated in injectors 50 and 100, the interior of combustion chamber 30, intake valve 80 and other places. Particularly, in in-cylinder injector 50, deposits would accumulate at the tip end portion, since the tip end temperature is likely to increase. With an increase of the deposit accumulation to the injector, the actual fuel injection amount becomes insufficient, which leads to an increase of air-fuel ratio control learning value ΔFaf.

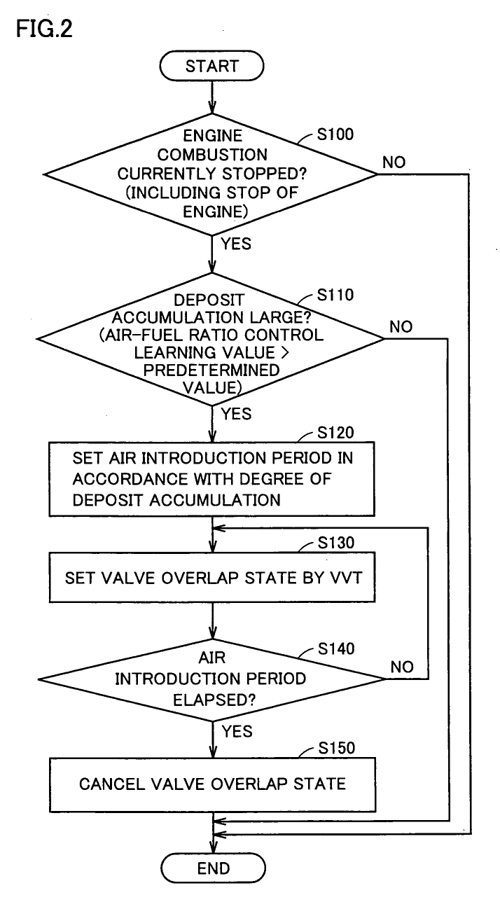

FIG. 2 is a flowchart illustrating deposit removal control according to the first embodiment of the present invention. The flowchart shown in FIG. 2 is implemented by engine ECU 300 that executes processing in accordance with a predetermined program.

Referring to FIG. 2, engine ECU 300 performs control of deposit removal from within the engine during the time when engine combustion is stopped (YES in step S100), by executing the following steps S110 to S150. It does not perform the deposit removal control in the first embodiment while the engine combustion is being performed (NO in S100).

In step S110, engine ECU 300 determines whether the degree of deposit accumulation in engine 5 is greater than a predetermined level. For example, if air-fuel ratio control learning value ΔFaf at that time point exceeds a predetermined reference value Fj, it is expected that the deposit accumulation to the injector is large, so that it determines that the degree of deposit accumulation in engine 5 is greater than the predetermined level. If air-fuel ratio control learning value ΔFaf is not greater than the reference value Fj, it is not determined that the deposit accumulation is large, in which case the deposit removal control by the subsequent steps is not carried out.

Upon detection of deposit accumulation in a large amount (YES in step S110), in step S120, engine ECU 300 sets an air introduction period for removal of deposits in accordance with the degree of deposit accumulation. That is, the air introduction period can be set based on air-fuel ratio control learning value ΔFaf at that time point.

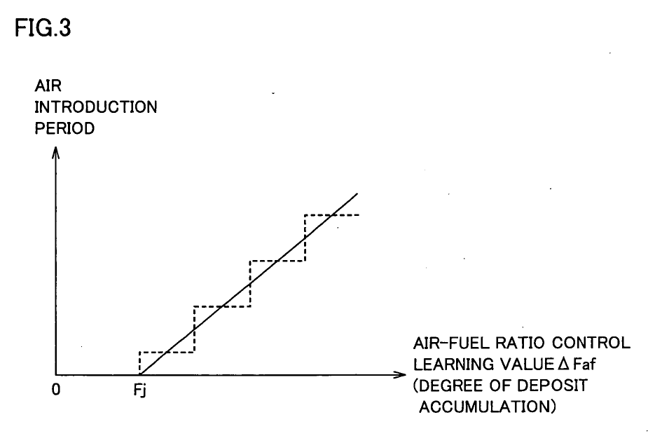

For example, as shown by a solid line in. FIG. 3, the air introduction period may be set continuously in a region exceeding reference value Fj, in association with the increase in air-fuel ratio control learning value ΔFaf that indicates the degree of deposit accumulation. Alternatively, the air introduction period may be set in a stepwise manner, as shown by a broken line in FIG. 3, in accordance with the increase in air-fuel ratio control learning value ΔFaf.

Referring again to FIG. 2, in step S130, engine ECU 300 sets valve timing such that an overlap period where both intake valve 80 and exhaust valve 90 are opened is guaranteed during the air introduction period (preferably such that the overlap period becomes the greatest possible value within the operable range). More specifically, engine ECU 300 issues a control instruction to VVT control unit 310 to set the valve timing. VVT control unit 310 is provided with a mechanism that guarantees mechanical power to change the phase of the camshaft by generating hydraulic pressure by an electric pump or the like even during engine stop. Alternatively, in the case where the hydraulic pressure for changing the phase of the shaft is generated by a pump of engine driven type, a mechanism that locks the camshaft to a desired phase during engine stop may be provided to set the valve timing to ensure the air introduction as described above.

By step S130, both intake valve 80 and exhaust valve 90 are opened in a certain cylinder in accordance with the crank angle at that time point. This creates an air introduction path from intake manifold 60 through combustion chamber 30 to exhaust manifold 70 via the thus opened intake valve 80 and exhaust valve 90, so that the air is introduced into combustion chamber 30, i.e., to the interior of engine 5. In this manner, the deposits once accumulated inside the engine, i.e., not only the deposits accumulated in in-cylinder injector 50, but also the deposits accumulated in intake manifold injector 100, intake valve 80, interior of combustion chamber 30 and the like, are subjected to drying and weathering by the introduced air. As such, the accumulated deposits attain the state where they are readily peeled off after next start of engine combustion.

The setting of the overlap state in step S130 is performed continuously as long as a lapse of the air introduction period set in step S120 is not detected in step S140 (while the determination in step S140 is NO).

After a lapse of the air introduction period (YES in step S140), in step S150, engine ECU 300 cancels the valve overlap state set in step S130. Correspondingly, a normal valve initial state at the time of engine stop (typically, valve timing of the most retarded state with which overlap would not occur) is set by means of a lock pin (not shown) provided at a vane (not shown) or the like for locking the phase of the camshaft.

With the deposit removal control as described above, upon detection of the deposit accumulation within the engine, the air introduction path into the combustion chamber is formed during the stop of engine combustion, to dry and weather the accumulated deposits. Accordingly, the deposits are easily peeled off and removed after initiation of next engine combustion.

It is noted that the “engine combustion currently stopped” state determined in step S100 may include, besides the state where the engine is stopped by the instruction of the driver, the state where the engine is temporarily stopped automatically in the case of a vehicle mounted with an economy running system that automatically stops the engine when a predetermined condition is satisfied, and the state where the engine is stopped during the running state of a hybrid vehicle mounted with the engine and another vehicle motive power source (typically, an electric motor).

As described above, the cylinder where the air can be introduced into the combustion chamber by opening both intake valve 80 and exhaust valve 90 is determined in accordance with the crank angle during the engine combustion stopped state. This means that, if a mechanism to control the crank stop angle at the time of stop of engine combustion is provided, the crank stop angle set value can sequentially be changed to introduce the air into the cylinders in turn, for peeling off and removing the deposits.

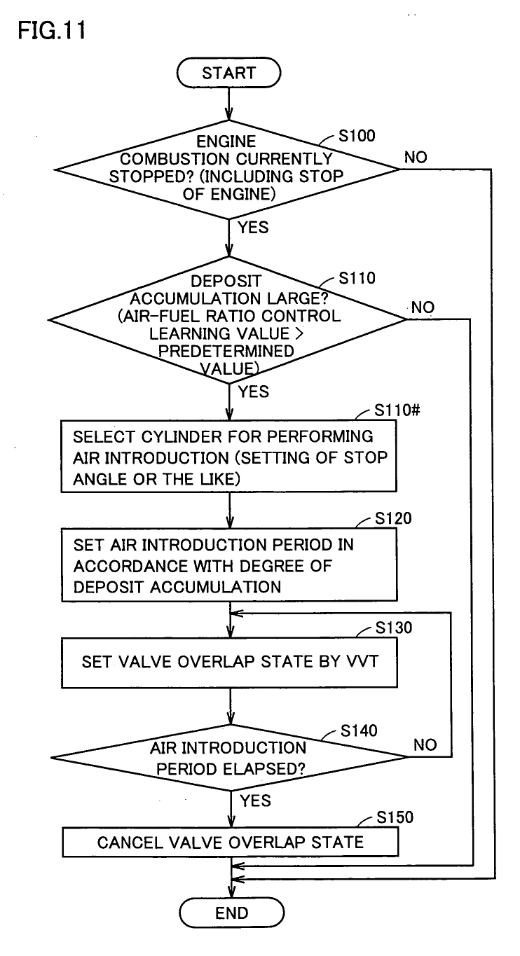

More specifically, as shown in FIG. 11, when it is determined in step S110 that the degree of deposit accumulation is greater than a predetermined level (YES in step S110), step S110# may be conducted to sequentially switch the setting of the crank stop angle to change the cylinder to be set to the valve overlap state (i.e., the cylinder as the target of the air introduction) each time the engine stops. Such control is suitable for the vehicle mounted with the economy running system or the hybrid vehicle in which the engine combustion would be stopped frequently.

As to the correspondence of the configuration of the present invention with the flowcharts in FIGS. 2 and 11, steps S110 and S130 correspond to the “detection means” and the “air introduction means”, respectively, of the present invention, and step S110# in FIG. 11 corresponds to the “cylinder selection means” of the present invention.

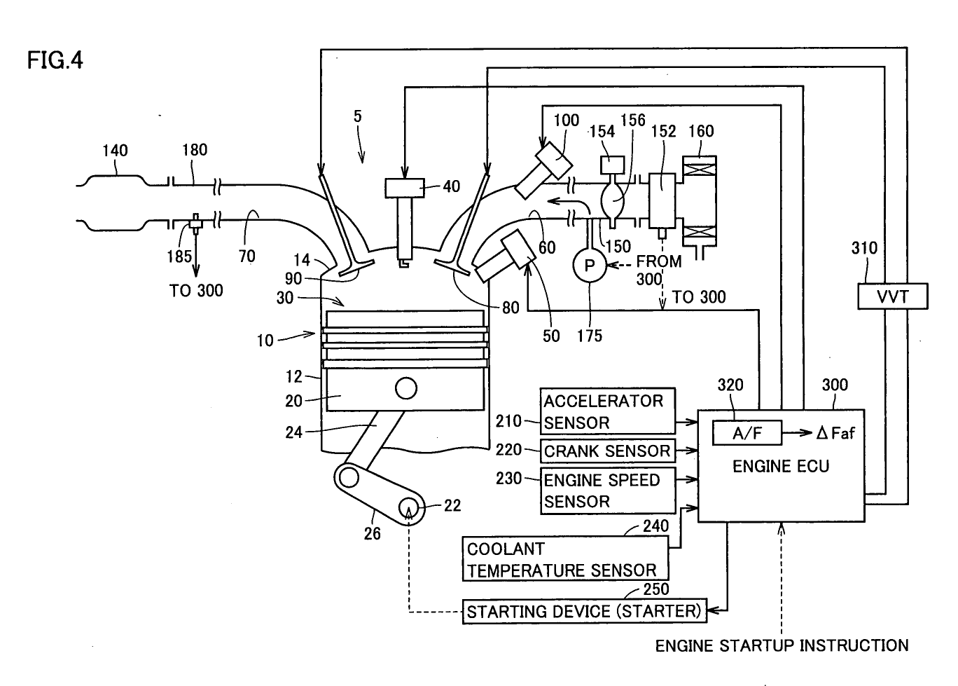

It is noted that an air pump 175 compressing and delivering the air may further be provided on the downstream side (on the intake manifold 60 side) of throttle valve 170, as shown in FIG. 4. Air pump 175 is activated by an operation instruction from engine ECU 300 during the valve overlap state set period in step S130 in FIG. 2.

When the air compressed and delivered by air pump 175 is flown through the air introduction path described above, the amount of the air introduced into engine 5 increases, which further enhances the deposit removal effect. That is, the operating period of air pump 175 is controlled by engine ECU 300 in association with the air introduction period set in step S120 (FIG. 2).

In the case of an engine configured to directly control the opening/closing of intake valve 80 and exhaust valve 90 in an electronic manner without the intervention of the camshaft, a valve opening instruction may be issued to both intake valve 80 and exhaust valve 90 in each cylinder in step S130, in which case the air introduction period for removal of deposits can be set for every cylinder all at once.

Further, in the case of an engine having both in-cylinder injector 50 and intake manifold injector 100 as shown in FIG. 1, when the deposit removal effect is increased by application of the present invention, the necessity to forcibly set the period of injecting fuel from in-cylinder injector 50 from the standpoint of preventing deposit accumulation as in Patent Document 1 decreases. Thus, it becomes possible to control the fuel injection ratio between the injectors corresponding to the engine conditions more precisely. As a result, running performance can further be improved.

### Second Embodiment

In the second embodiment, description will be made about deposit removal control during the stop of engine combustion in a hybrid vehicle.

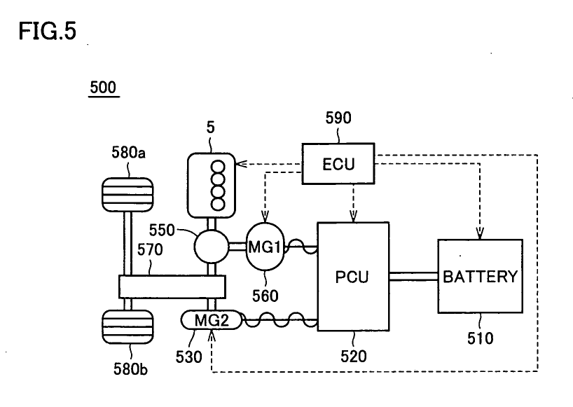

Firstly, a schematic configuration of a hybrid vehicle that is controlled by the control apparatus for a vehicle according to the second embodiment of the present invention will be described with reference to FIG. 5.

Referring to FIG. 5, a hybrid vehicle 500 includes, in addition to an engine 5, a battery 510, a power control unit (PCU) 520 for power conversion, motor generators 530 and 560 each capable of operating as both an electric motor and an electric generator, a power split device 550, a reduction gear 570, driving wheels 580a and 580b, and a hybrid ECU 590 controlling the overall operation of hybrid vehicle 500.

Although a hybrid vehicle in which only the front wheels are driving wheels is shown in FIG. 5, an electric motor for driving the rear wheels can be provided to constitute a 4WD hybrid vehicle.

Battery 510 is formed of a rechargeable secondary battery (for example, a nickel-hydrogen or lithium-ion secondary battery). PCU 520 includes an inverter (not shown) to convert the direct-current voltage supplied from battery 510 into alternating voltage for driving motor generator 530 (MG2). The inverter is configured to allow bidirectional power conversion, and also has the function of converting the generated power (alternating voltage) by the regenerative braking operation of MG2 and the generated power (alternating voltage) by motor generator 560 (MG1) into direct-current voltage for charging battery 510.

PCU 520 may further include an up/down converter (not shown) to convert the level of the direct-current voltage. Arrangement of such an up/down converter allows MG2 to be driven by an alternating voltage with an amplitude of a voltage higher than the voltage supplied by battery 510. Therefore, the electric motor driving efficiency can be improved.

The engine system shown in FIG. 1, for example, can be applied for engine 5. Power split device 550 can divide the output power of the engine into a path for transmission to driving wheels 580a and 580b via reduction gear 570, and a path for transmission towards MG1. MG1 is rotated by the output power of engine 5 transmitted via power split device 550 to generate electric power. The electric power generated by MG1 is used by PCU 520 as the electric power to charge battery 510 or as the electric power to drive MG2.

Engine 5 may be rotatably driven by the output of MG1 via power split device 550. Typically, at the startup of engine 5, the output of MG1 provides the rotational force to crankshaft 22 of engine 5. That is, in hybrid vehicle 500, MG1 constitutes starter 250 shown in FIG. 1.

MG2 is driven rotatably by the alternating voltage supplied from PCU 520. The output power of MG2 is transmitted to driving wheels 580a and 580b via reduction gear 570 to provide the vehicle motive power. That is, MG2 corresponds to the “other motive power source” different from the engine (internal combustion engine) in the present invention. During the regenerative braking operation mode in which MG2 is rotated in accordance with the reduced rate of driving wheels 580a and 580b, MG2 functions as an electric generator.

At the start of operation of the hybrid vehicle, the hybrid system is activated, and battery 510 serving as the wheel driving power source is connected to MG2, so that running by MG2 becomes possible. Meanwhile, at the stop of operation of the hybrid vehicle, the hybrid system is stopped, and battery 510 is disconnected from MG2.

At the time of starting the vehicle and at the time of light load when running at low speed or running down a gentle slope, hybrid vehicle 500 runs by the motive power from MG2 without using the motive power of engine 5 in order to avoid the region of poor engine efficiency. In this case, the operation of engine 5 is ceased except for the case where warm up operation or battery charging operation is required. Engine 5 is operated under an idling state when warm up operation or battery charging operation is required.

In a normal running mode, engine 5 is started and the motive power output therefrom is divided into the motive power of driving wheels 580a and 580b and the motive power for electric power generation at MG1 by power split device 550. The generated electric power from MG1 is used to drive electric motor 530 (MG2). Therefore, driving wheels 580a and 580b are driven, assisting the motive power from engine 5 by the motive power from MG2 in a normal running mode.

Hybrid ECU 590 corresponding to the control apparatus for a vehicle according to the second embodiment of the present invention controls the power split ratio of power split device 550 such that the overall efficiency becomes greatest. Further, in an acceleration mode of full throttle, the power supplied from battery 510 is used for driving MG2, whereby the motive power of driving wheels 580a and 580b is further increased.

During the time of deceleration and braking, MG2 is driven rotatably by driving wheels 580a and 580b to generate electric power. The electric power collected by the regeneration of MG2 is converted into direct-current voltage by PCU 520 to be used for charging battery 510. Engine 5 is ceased automatically when the vehicle stops.

Hybrid vehicle 500 conducts vehicle cruising with power consumption improved based on the combination of the motive power generated by engine 5 and the motive power generated by MG2 based on the electric energy as the source, i.e., controlling the operation of engine 5 and MG1 and MG2 depending upon the driving status. Specifically, hybrid ECU 590 controls allocation of tasks in generating motive power (hereinafter, also referred to as “(motive) power output ratio”) between MG2 and engine 5 in accordance with the operation status of the vehicle. The functional portion for such motive power allocation by hybrid ECU 590 corresponds to the “motive power allocation means” of the present invention. Further, MG1 and MG2 shown in FIG. 5 correspond to the “first electric motor” and the “second electric motor”, respectively, of the present invention.

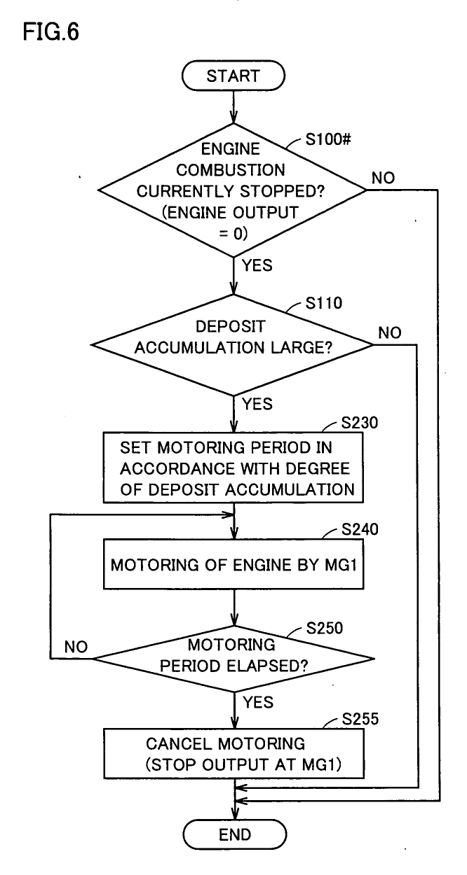

FIG. 6 is a flowchart illustrating a first example of deposit removal control according to the second embodiment of the present invention. In each example of deposit removal control according to the second embodiment described hereinbelow as well, the deposit removal control is implemented by hybrid ECU 590 that executes processing in accordance with a predetermined program.

Referring to FIG. 6, in step S100#, hybrid ECU 590 detects whether the engine combustion is currently stopped. The engine combustion stopped state can be detected, e.g., according to whether engine output=0 or not based on the above-described power output ratio between engine 5 and MG2.

During the engine combustion stopped state (YES in step S100#), hybrid ECU 590 determines whether the deposit accumulation within the engine is large in step S110 that is identical to step S110 of the first embodiment (FIG. 2).

If NO in either step S100# or step S110, the subsequent steps are not executed, which means that the deposit removal control is not conducted.

If YES in step S110, a motoring period is set in step S230 in accordance with the degree of deposit accumulation. The motoring period is set according to the degree of deposit accumulation in a manner similar to setting of the air introduction period in the first embodiment (FIG. 2). For example, the process in step S230 may be carried out by modifying FIG. 3 so that the vertical axis represents the motoring period.

Further, in step S240, hybrid ECU 590 causes motoring of engine 5 by the output of MG1, while stopping combustion of engine 5. During the motoring period, the operations of intake valve 80 and exhaust valve 90 in engine 5 are set in a manner similar to the case of the normal engine operation mode.

An air introduction path is formed within engine 5 by motoring, and thus, the deposits once accumulated inside the engine are subjected to drying and weathering by the introduced air. This ensures that the deposits attain the state where they will readily be peeled off after the next start of engine combustion.

The motoring in step S240 is performed continuously as long as a lapse of the motoring period set in step S230 is not detected in step S250 (while the determination in step S250 is NO).

After a lapse of the motoring period (YES in step S250), hybrid ECU 590 cancels the motoring by MG1 in step S255. As such, engine 5 is set to a normal stopped state.

With such deposit removal control, in the hybrid vehicle, MG1 arranged in a manner capable of rotatably driving engine 5 performs motoring of the engine during the engine combustion stopped state. This enables drying and weathering of the once accumulated deposits by the air introduced into the combustion chamber, so that the deposits are likely to be peeled off and removed after the start of engine combustion next time.

Alternatively, in the hybrid vehicle, the engine combustion stopped state may be intentionally created upon detection of deposit accumulation, to perform the deposit removal control.

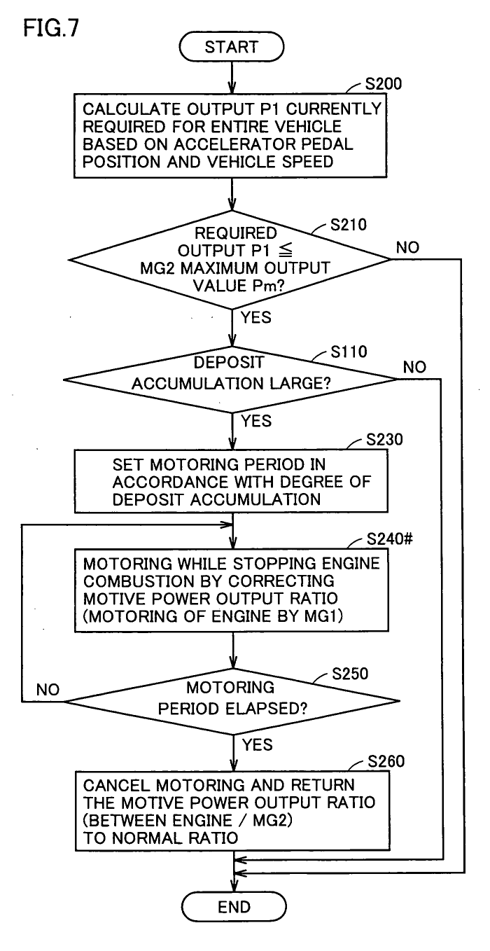

FIG. 7 is a flowchart illustrating a second example of the deposit removal control according to the second embodiment of the present invention.

Referring to FIG. 7, in step S200, hybrid ECU 590 calculates output P1 required for the entire vehicle based on the accelerator pedal position and the vehicle speed at that time point.

Further, in step S210, hybrid ECU 590 determines whether the total required output P1 calculated in step S200 is equal to or less than a motor limit output Pm corresponding to the motive power that can be output by MG2 alone.

If the required output P1 for the entire vehicle exceeds motor limit output Pm, the subsequent steps are not conducted, and thus, the deposit removal control according to the second example of the second embodiment is not carried out.

If total required output P1 is equal to or less than motor limit output Pm (YES in step S210), it is determined whether the deposit accumulation is large or not in step S110 identical to that of the first embodiment (FIG. 2).

If the deposit accumulation is large, i.e., if determination in step S110 is YES, step S230 identical to that in FIG. 6 is carried out to set the motoring period in accordance with the degree of deposit accumulation.

Further, in step S240#, hybrid ECU 590 corrects the motive power output ratio to set engine output=0 to thereby stop engine combustion. It also performs motoring of engine 5 by MG1 in a manner similar to that in step S240. That is, MG2 outputs power corresponding to the output P1 required for the entire vehicle.

The motoring in step S240# is performed continuously as long as a lapse of the motoring period set in step S230 is not detected in step S250 (while determination in step S250 is NO).

After a lapse of the motoring period (YES in step S250), in step S260, hybrid ECU 590 cancels the motoring by MG1, and changes the motive power output ratio between engine 5 and MG2 from the corrected state in step S240 to the normal state. Thus, the state of forcibly stopping combustion of engine 5 is cancelled, and a normal operation is restarted.

With such deposit removal control, in the hybrid vehicle, in the event that running is possible with the output of MG2 alone, motoring of the engine is performed aggressively by correcting the motive power output ratio upon detection of deposit accumulation. This allows the once accumulated deposits to be subjected to drying and weathering, to facilitate peeling off and removal thereof.

The motoring of engine 5 would lower the temperature of the catalyst. An excessively decreased temperature of the catalyst may cause degradation of the exhaust emission efficiency. Thus, when performing deposit removal control involving aggressive motoring of the engine, it is preferable to concurrently monitor the temperature of the catalyst.

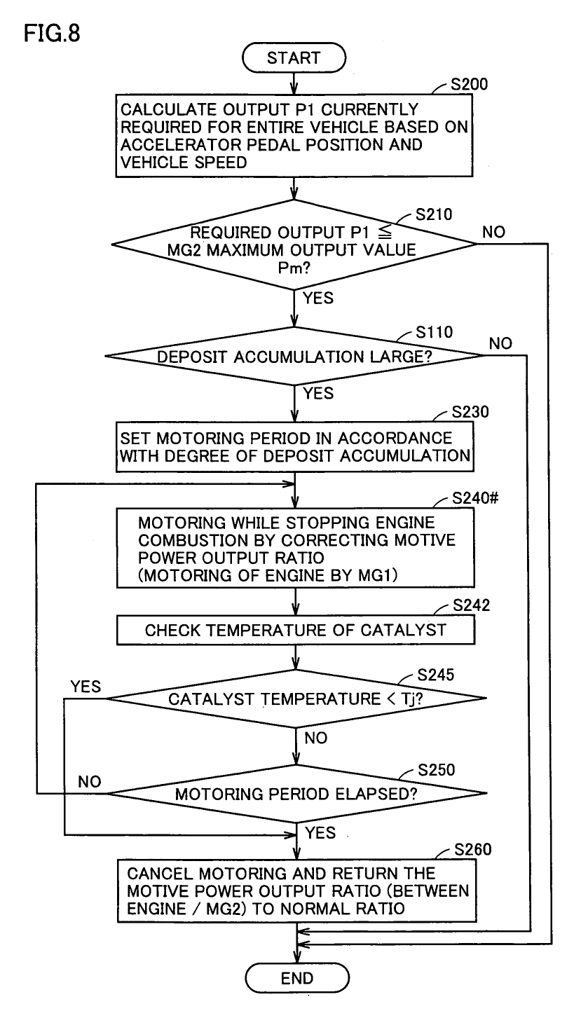

FIG. 8 is a flowchart illustrating a third example of the deposit removal control according to the second embodiment of the present invention.

Comparing FIG. 8 with FIG. 7, in the deposit removal control according to the third example of the second embodiment, hybrid ECU 590 further conducts steps S242 and S245 for checking the temperature of the catalyst during the execution of motoring in step S240#. In the flowchart of FIG. 8, the control structure in the remaining portions is identical to that in FIG. 7, and thus, detailed description thereof will not be repeated.

In step S242, hybrid ECU 590 checks the temperature of the catalyst during the execution of motoring in step S240#.

For checking the temperature of the catalyst, a temperature sensor may be provided at three-way catalytic converter 140 to check the output value of the sensor. Alternatively, an estimate of the temperature of the catalyst may be calculated based on the amount of the air (intake air amount) passed through three-way catalytic converter 140 and its temperature, and the estimated value may be checked.

In step S245, hybrid ECU 590 determines whether the temperature of the catalyst checked in step S242 is lower than a predetermined reference temperature Tj. The reference temperature Tj may be set as appropriate in accordance with the properties of three-way catalytic converter 140 and the required level of exhaust emission efficiency.

If the temperature of the catalyst is lower than reference value Tj (YES in step S245), hybrid ECU 590 stops the motoring control by executing step S260, even if the motoring period has not been elapsed yet, in order to prevent degradation of the exhaust emission efficiency due to the decrease of the catalyst temperature by motoring.

If the temperature of the catalyst is equal to or higher than reference value Tj (NO in step S245), the deposit removal operation by motoring of engine 5 is carried out, in the same manner as in the deposit removal control in FIG. 7, until the motoring period set in step S230 expires.

This deposit removal control provides, in addition to the effect of deposit removal control in accordance with the flowchart shown in FIG. 7, the effect of preventing the unwanted situation where the temperature of the catalyst is decreased too low due to the motoring and the efficiency in exhaust emission is degraded.

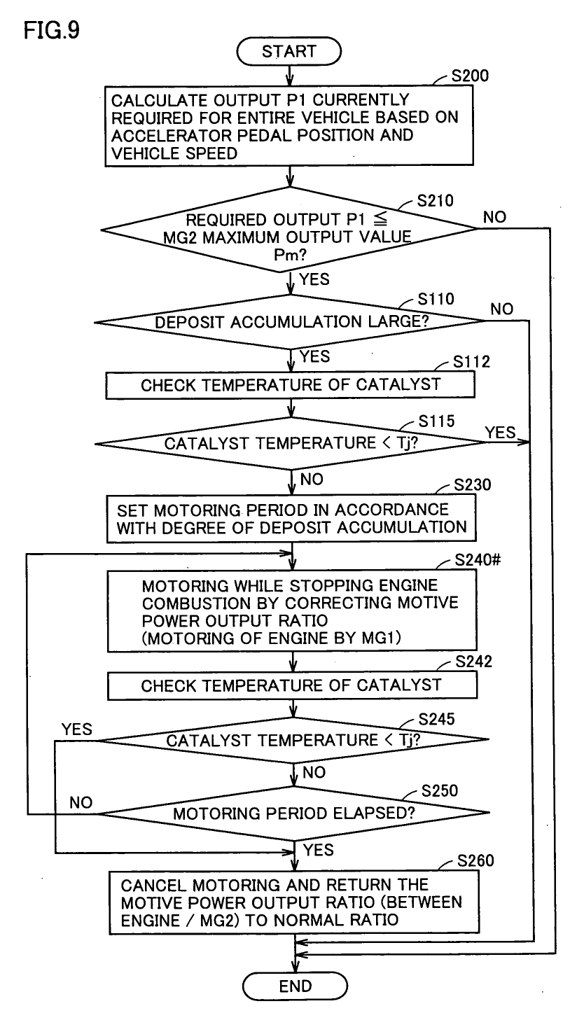

Alternatively, it may be configured such that the temperature of the catalyst is used as an additional condition for determination as to whether the motoring period should be set or not, as in a modification shown in FIG. 9.

Referring to FIG. 9, when it is determined that the deposit accumulation is large in step S110, steps S112 and S115, which are identical to steps S242 and S245, may be conducted so as to prohibit setting of the motoring period when the temperature of the catalyst is lower than a predetermined reference temperature Tj. As such, it is possible to prevent the adverse situation where the temperature of the catalyst further decreases due to execution of the motoring, that would lead to degradation of the exhaust emission efficiency. It is noted that the reference temperatures of different values may be set in steps S115 and S245.

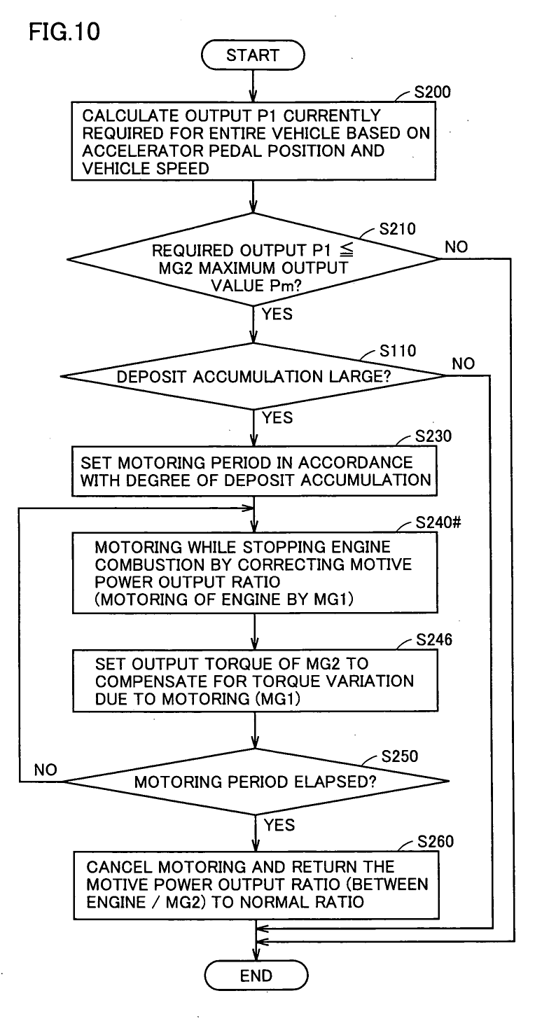

FIG. 10 is a flowchart illustrating a fourth example of the deposit removal control according to the second embodiment of the present invention.

Comparing FIG. 10 with FIG. 7, in the deposit removal control of the fourth example according to the second embodiment, hybrid ECU 590 further executes step S246 at the time of execution of motoring in step S240#. The control structure of the remaining portions in the flowchart of FIG. 10 is identical to that in FIG. 7, and thus, detailed description thereof will not be repeated.

In step S246, hybrid ECU 590 performs output torque setting of MG2 to compensate for the variation in torque that would occur to the axle due to the motoring by MG1. More specifically, when the output torque corresponding to the total required output P1 is represented as T1 and the output torque for canceling out the torque variation Tm generated to the axle by the motoring by MG1 is represented as T2 (i.e., T2+Tm=0), the torque set value Tcom for MG2 is set to: Tcom=T1+T2.

Such a control structure can suppress occurrence of variation in the vehicle motive power at the time of execution of motoring for deposit removal. It is noted that the flowcharts shown in FIGS. 8, 9 and 10 may be combined such that steps S242, S245 in FIGS. 8, 9 and/or steps S112, S115 in FIG. 9 may be added after execution of step S246 and/or after execution of step S110.

Steps S240, S240# in the flowcharts shown in FIGS. 6-10 correspond to the “air introduction means” of the present invention. Further, in FIGS. 8 and 9, steps S112, S242 correspond to the “temperature detection means”, step S245 corresponds to the “motoring stop means”, and step S115 corresponds to the “motoring prohibiting means” of the present invention.

Further, in step S230, the duration of the motoring period in which power consumption by MG1 occurs may be set in a variable manner based on the degree of deposit accumulation. This prevents unnecessary consumption of the battery power, and thus can improve fuel efficiency.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A control apparatus for a vehicle having an internal combustion engine arranged in a manner capable of transmitting power to an axle, comprising:
detection means for detecting degree of deposit accumulation in said internal combustion engine; and
air introduction means for introducing the air into said internal combustion engine in a combustion stopped state of said internal combustion engine when said detection means detects that said degree of deposit accumulation is greater than a predetermined level.

2. The control apparatus for a vehicle according to claim 1, further comprising valve control means for controlling opening/closing of an intake valve and an exhaust valve of said internal combustion engine, wherein
said air introduction means includes means for instructing said valve control means to perform control such that said intake valve and said exhaust valve in at least one cylinder are set to an open state in the combustion stopped state of said internal combustion engine.

3. The control apparatus for a vehicle according to claim 2, wherein
said air introduction means further includes cylinder selection means for selecting an air introduction cylinder in which said intake valve and said exhaust valve are set to the open state in the combustion stopped state of said internal combustion engine,
said cylinder selection means changing said air introduction cylinder each time said internal combustion engine stops.

4. The control apparatus for a vehicle according to claim 1, wherein
said vehicle further includes a first electric motor arranged in a manner capable of transmitting power to said internal combustion engine, and
said air introduction means includes means for performing motoring of said internal combustion engine for a predetermined period by said first electric motor in the combustion stopped state of said internal combustion engine.

5. The control apparatus for a vehicle according to claim 4, wherein
said vehicle further includes another motive power source different from said internal combustion engine and arranged in a manner capable of transmitting power to said axle,
said control apparatus further comprising:
motive power allocation means for controlling a motive power output ratio between said internal combustion engine and said other motive power source with respect to total motive power required for said vehicle as a whole, and
said air introduction means includes means for setting motive power output by said internal combustion engine to zero to stop combustion of said internal combustion engine in the case where said total motive power is not greater than motive power that can be output by said other motive power source and said detection means detects that said degree of deposit accumulation is greater than the predetermined level.

6. The control apparatus for a vehicle according to claim 5, wherein
said other motive power source includes a second electric motor arranged in a manner capable of transmitting power to said axle, and
said second electric motor has output torque set in accordance with a sum of first torque corresponding to said total motive power and second torque for canceling out torque that is transmitted to said axle by the motoring of said internal combustion engine by said first electric motor.

7. The control apparatus for a vehicle according to claim 4, wherein
said vehicle further includes a catalyst arranged to allow an exhaust gas of said internal combustion engine to pass therethrough,
said control apparatus further comprising:
temperature detection means for detecting a temperature of said catalyst; and
motoring stop means for stopping motoring of said internal combustion engine by said air introduction means in response to the event that said temperature detection means detects the temperature of said catalyst decreased to a level lower than a predetermined reference value during the motoring of said internal combustion engine.

8. The control apparatus for a vehicle according to claim 4, wherein
said vehicle further includes a catalyst arranged to allow an exhaust gas of said internal combustion engine to pass therethrough,
said control apparatus further comprising:
temperature detection means for detecting a temperature of said catalyst; and
motoring prohibiting means for prohibiting execution of motoring of said internal combustion engine by said air introduction means, even in the case where said detection means detects that said degree of deposit accumulation is greater than said predetermined level, when said temperature detection means detects that the temperature of said catalyst is lower than a predetermined reference value.

9. The control apparatus for a vehicle according to claim 4, wherein said predetermined period is set in a variable manner in accordance with said degree of deposit accumulation detected by said detection means.

10. The control apparatus for a vehicle according to claim 1, wherein said internal combustion engine includes first fuel injection means for injecting fuel directly into a combustion chamber.

11. The control apparatus for a vehicle according to claim 10, wherein said internal combustion engine further includes second fuel injection means for injecting fuel into an intake manifold.

12. The control apparatus for a vehicle according to claim 1, further comprising air-fuel ratio control means for controlling a fuel injection amount based on a detected value of an air-fuel ratio in said internal combustion engine to maintain the air-fuel ratio at a target value, wherein
said detection means detects said degree of deposit accumulation based on a compensation amount of said fuel injection amount by said air-fuel ratio control means.

13. A control apparatus for a vehicle having an internal combustion engine arranged in a manner capable of transmitting power to an axle, comprising:
a detection portion detecting degree of deposit accumulation in said internal combustion engine; and
an air introduction portion introducing the air into said internal combustion engine in a combustion stopped state of said internal combustion engine when said detection portion detects that said degree of deposit accumulation is greater than a predetermined level.

14. The control apparatus for a vehicle according to claim 13, further comprising a valve control portion controlling opening/closing of an intake valve and an exhaust valve of said internal combustion engine, wherein
said air introduction portion instructs said valve control portion to perform control such that said intake valve and said exhaust valve in at least one cylinder are set to an open state in the combustion stopped state of said internal combustion engine.

15. The control apparatus for a vehicle according to claim 14, wherein
said air introduction portion further includes a cylinder selection portion selecting an air introduction cylinder in which said intake valve and said exhaust valve are set to the open state in the combustion stopped state of said internal combustion engine,
said cylinder selection portion changing said air introduction cylinder each time said internal combustion engine stops.

16. The control apparatus for a vehicle according to claim 13, wherein
said vehicle further includes a first electric motor arranged in a manner capable of transmitting power to said internal combustion engine, and
said air introduction portion performs motoring of said internal combustion engine for a predetermined period by said first electric motor in the combustion stopped state of said internal combustion engine.

17. The control apparatus for a vehicle according to claim 16, wherein
said vehicle further includes another motive power source different from said internal combustion engine and arranged in a manner capable of transmitting power to said axle,
said control apparatus further comprising:
a motive power allocation portion controlling a motive power output ratio between said internal combustion engine and said other motive power source with respect to total motive power required for said vehicle as a whole, and
said air introduction portion sets motive power output by said internal combustion engine to zero to stop combustion of said internal combustion engine in the case where said total motive power is not greater than motive power that can be output by said other motive power source and said detection portion detects that said degree of deposit accumulation is greater than the predetermined level.

18. The control apparatus for a vehicle according to claim 17, wherein
said other motive power source includes a second electric motor arranged in a manner capable of transmitting power to said axle, and
said second electric motor has output torque set in accordance with a sum of first torque corresponding to said total motive power and second torque for canceling out torque that is transmitted to said axle by the motoring of said internal combustion engine by said first electric motor.

19. The control apparatus for a vehicle according to claim 16, wherein
said vehicle further includes a catalyst arranged to allow an exhaust gas of said internal combustion engine to pass therethrough,
said control apparatus further comprising:
a temperature detection portion detecting a temperature of said catalyst; and
a motoring stop portion stopping motoring of said internal combustion engine by said air introduction portion in response to the event that said temperature detection portion detects the temperature of said catalyst decreased to a level lower than a predetermined reference value during the motoring of said internal combustion engine.

20. The control apparatus for a vehicle according to claim 16, wherein
said vehicle further includes a catalyst arranged to allow an exhaust gas of said internal combustion engine to pass therethrough,
said control apparatus further comprising:
a temperature detection portion detecting a temperature of said catalyst; and
a motoring prohibiting portion prohibiting execution of motoring of said internal combustion engine by said air introduction portion, even in the case where said detection portion detects that said degree of deposit accumulation is greater than said predetermined level, when said temperature detection portion detects that the temperature of said catalyst is lower than a predetermined reference value.

21. The control apparatus for a vehicle according to claim 16, wherein said predetermined period is set in a variable manner in accordance with said degree of deposit accumulation detected by said detection portion.

22. The control apparatus for a vehicle according to claim 13, wherein said internal combustion engine includes a first fuel injection mechanism injecting fuel directly into a combustion chamber.

23. The control apparatus for a vehicle according to claim 22, wherein said internal combustion engine further includes a second fuel injection mechanism injecting fuel into an intake manifold.

24. The control apparatus for a vehicle according to claim 13, further comprising an air-fuel ratio control portion controlling a fuel injection amount based on a detected value of an air-fuel ratio in said internal combustion engine to maintain the air-fuel ratio at a target value, wherein
said detection portion detects said degree of deposit accumulation based on a compensation amount of said fuel injection amount by said air-fuel ratio control portion.

25. A vehicle, comprising:
an internal combustion engine arranged in a manner capable of transmitting power to an axle; and
a control apparatus;
said control apparatus detecting degree of deposit accumulation in said internal combustion engine, and introducing the air into said internal combustion engine in a combustion stopped state of said internal combustion engine when a detected value of said degree of deposit accumulation is greater than a predetermined level.
